(19) United States
(12) Patent Application Publication
(10) Pub. No.: US 2022/0416245 A1
(43) Pub. Date: Dec. 29, 2022

(54) NEGATIVE ELECTRODE FOR NONAQUEOUS ELECTROLYTE SECONDARY BATTERIES, NONAQUEOUS ELECTROLYTE SECONDARY BATTERY, AND METHOD FOR PRODUCING NEGATIVE ELECTRODE FOR NONAQUEOUS ELECTROLYTE SECONDARY BATTERIES

(71) Applicant: SANYO Electric Co., Ltd., Kadoma-shi, Osaka (JP)

(72) Inventors: Fumikazu Mizukoshi, Osaka (JP); Takamitsu Tashita, Tokushima (JP)

(73) Assignee: SANYO Electric Co., Ltd., Kadoma-shi, Osaka (JP)

(21) Appl. No.: 17/778,998

(22) PCT Filed: Nov. 19, 2020
(86) PCT No.: PCT/JP2020/043101

§ 371 Date: May 23, 2022

(30) Foreign Application Priority Data
Nov. 29, 2019 (JP) 2019-217518

(51) Int. Cl. H01M 4/60; H01M 4/38

(52) U.S. Cl. CPC H01M 4/602; H01M 4/386; H01M 2004/027

(57) ABSTRACT

A first negative electrode mixture layer contains a first negative electrode active material and a first water-soluble polymer material; and a second negative electrode mixture layer contains a second negative electrode active material and a second water-soluble polymer material. The ratio of the amount (S1) of the first water-soluble polymer material present on the surface of the first negative electrode active material to the amount (V1) of the first water-soluble polymer material present in voids among particles of the first negative electrode active material, namely S1/V1 is larger than the ratio of the amount (S2) of the second water-soluble polymer material present on the surface of the second negative electrode active material to the amount (V2) of the second water-soluble polymer material present in voids among particles of the second negative electrode active material, namely S2/V2.

### TECHNICAL FIELD

The present disclosure relates to a negative electrode for a non-aqueous electrolyte secondary, battery, a non-aqueous electrolyte secondary battery, and a. method for producing a negative electrode for a non-aqueous electrolyte secondary battery.

### BACKGROUND ART

A negative electrode constituting a non-aqueous electrolyte secondary battery generally has a negative electrode current collector, and a negative electrode mixture layer formed on each of both surfaces of the negative electrode current collector. The negative electrode mixture layer includes a negative electrode active material and a binder, and the binder binds particles of the negative electrode active material and binds the negative electrode active material and the negative electrode current collector to thereby allow the structure of the negative electrode mixture layer to be maintained.

Patent Literatures 1 and 2 each disclose a method for allowing a binder to adhere to a surface of a negative electrode active material by dry mixing the negative electrode active material with the binder and then producing a slurry. Thus, a mutually binding force of the negative electrode active material and a binding force between a negative electrode active material layer and a negative electrode current collector can be increased to result in enhancements in cycle characteristics, as described in Patent Literature 1, and the binder retains an electrolyte solution to result in an enhancement in charge-discharge efficiency. as described in Patent Literature 2.

### CITATION LIST

### Patent Literature

PATENT LITERATURE1: Japanese Unexamined Patent Application Publication No. 2002-42787

PATENT LITERATURE 2: Japanese Unexamined Patent Application Publication No. 2005-166446

### SUMMARY

### Technical Problem

A non-aqueous electrolyte secondary battery when used as a power source for electric vehicles (EV) and the like, is often charged and discharged at a high rate, and therefore is demanded to be suppressed in deterioration in high-rate charge-discharge cycle characteristics. However, a negative electrode mixture layer including a negative electrode active material having a surface to which a large amount of a binder adheres is not good in permeability of an electrolyte solution, and thus high-rate charge-discharge cycle characteristics are sometimes deteriorated.

It is an advantage of the present disclosure to provide a negative electrode for a non-aqueous electrolyte secondary battery which can be suppressed in deterioration in high-rate charge-discharge cycle characteristics.

### Solution to Problem

A negative electrode for a non-aqueous electrolyte secondary battery of one aspect of the present disclosure comprises a negative electrode current collector, a first negative electrode mixture layer disposed on a surface of the negative electrode current collector, and a second negative electrode mixture layer disposed on a surface of the first negative electrode mixture layer. The first negative electrode mixture layer includes a first negative electrode active material and a first water-soluble polymer material, and the second negative electrode mixture layer includes a second negative electrode active material and a second water-soluble polymer material. A ratio (S1/V1) of an amount (S1) of the first water-soluble polymer material present in a surface of the first negative electrode active material to an amount (V1) of the first water-soluble polymer material present in voids between particles of the first negative electrode active material is higher than a ratio (S2/V2) of an amount (S2) of the second water-soluble polymer material present in a surface of the second negative electrode active material to an amount (V2) of the second water-soluble polymer material present in voids between particles of the second negative electrode active material.

A non-aqueous electrolyte secondary battery of one aspect of the present disclosure comprises the negative electrode for a non-aqueous electrolyte secondary battery, a positive electrode, and a non-aqueous electrolyte.

A method for producing a negative electrode for a non-agneous electrolyte secondary battery of one aspect of the present disclosure includes a first negative electrode mixture layer formation step of coating a surface of a negative electrode current collector with a first negative electrode mixture slurry prepared by kneading a first negative electrode active material and a first water-soluble polymer material, to form a first negative electrode mixture layer, and a second negative electrode mixture layer formation step of coating a surface of the first negative electrode mixture layer with a second negative electrode mixture shiny prepared by kneading a second negative electrode active material and a second water-soluble polymer material, to form a second negative electrode mixture layer, wherein a shear force in kneading of the first negative electrode mixture slurry is larger than a shear force in kneading of the second negative electrode mixture slurry.

### Advantageous Effects of Invention

According to one aspect of the present disclosure, a non-aqueous electrolyte secondary battery which can be suppressed in deterioration in high-rate charge-discharge cycle characteristics can be provided.

### BRIEF DESCRIPTION OF DRAWLNG

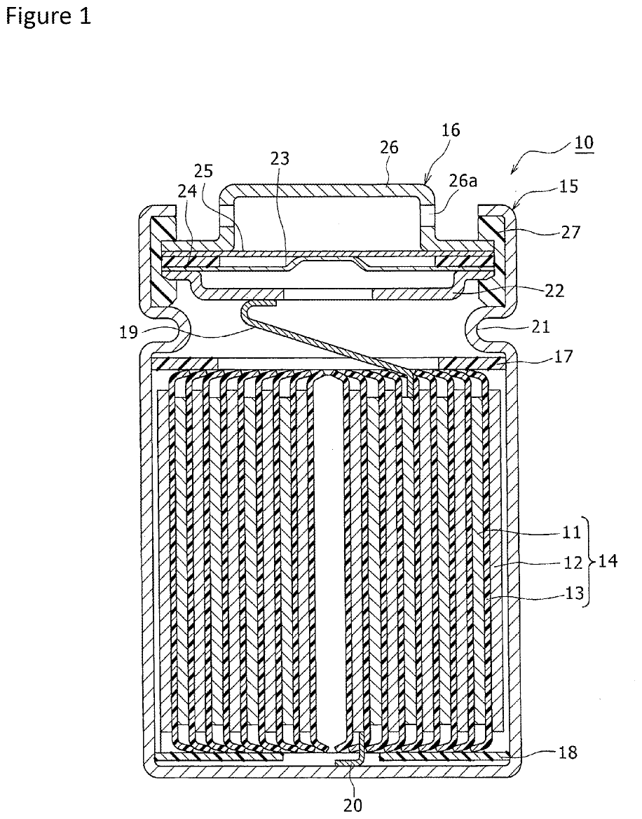

FIG. 1 is a longitudinal sectional view of a cylindrical-type secondary battery of an exemplary embodiment.

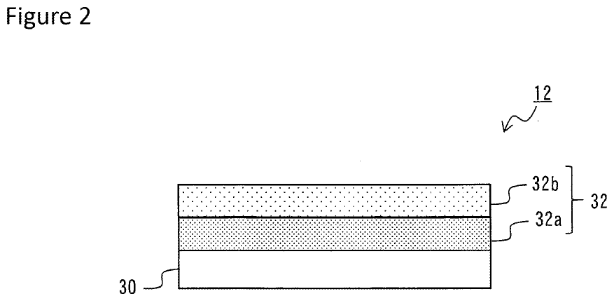

FIG. 2 is a sectional view of a negative electrode of an exemplary embodiment.

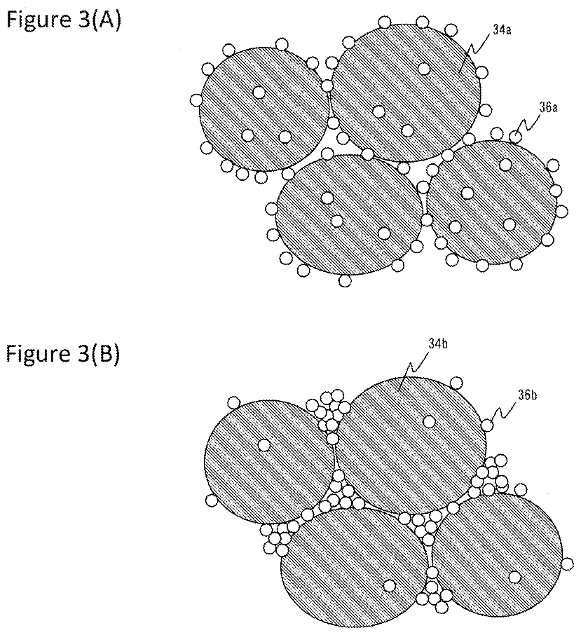

FIG. 3(A) is a schematic view showing one example of a cross section of a first negative electrode mixture layer, and FIG. 3(B) is a schematic view showing one example of a second negative electrode mixture layer.

### DESCRIPTION OF EMBODIMENTS

As described above, there is known a method for allowing a binder to adhere to a surface of a negative electrode active material by dry mixing the negative electrode active material with the binder and then producing a shiny. A water-soluble polymer material, for example, the binder can retain an electrolyte solution, and thus the water-soluble polymer material can adhere to a surface of the negative electrode active material to thereby bring the electrolyte solution into contact with a surface of the negative electrode active material not good in affinity with the electrolyte solution, such as a carbon material. However; it has been found according to studies by the present inventors that a negative electrode mixture layer including a negative electrode active material having a surface to which a water-soluble polymer material adheres may cause high-rate charge-discharge cycle characteristics to be sometimes deteriorated. The reason for this is considered because a negative electrode surface is deteriorated in permeability of an electrolyte solution to thereby cause distribution of the electrolyte solution in a negative electrode to be heterogenized during charge and discharge. The present inventors have made intensive studies, and as a result, have conceived a negative electrode for a non-aqueous electrolyte secondary battery, in which two negative electrode mixture layers are disposed, and a layer on an outer surface side, in contact with an electrolyte solution, is such that a water-soluble polymer material is more present in voids between particles of a negative electrode active material in order to improve permeability of the electrolyte solution and a layer on an jailer side, in contact with a negative electrode current collector, is such that a water-soluble polymer material is more present in a surface of a negative electrode active material in order to improve binding properties. According to the present negative electrode, a non-aqueous electrolyte secondary battery which can be suppressed in deterioration in high-rate charge-discharge cycle characteristics can be provided.

Hereinafter, an exemplary embodiment of a cylindrical-type secondary battery of the present disclosure will be described in detail with reference to drawings. In the following description, specific shapes, materials, numerical values, directions, and the like are illustrative for facilitating understanding of the present invention, and can be appropriately modified depending on the specification of the cylindrical-type secondary battery. An exterior body is not limited to a cylindrical-type body, and may be, for example, rectangular. When a plurality of embodiments and variants are included in the following description, it has been expected from the be inuring that feature portions are appropriately combined and used.

FIG. 1 is an axial sectional view of a cylindrical-type secondary battery 10 of an exemplary embodiment. In the secondary battery 10 shown in FIG. 1, an electrode assembly 14 and a non-aqueous electrolyte (not shown) are housed in an exterior body 15 The electrode assembly 14 has a wound-type structure formed by winding a positive electrode 11 and a negative electrode 12 with a separator 13 being interposed therebetween. Hereinafter, there will be described under the assumption that a sealing assembly 16 side is “upper” and a bottom side of the exterior body 15 is “lower”, for the purpose of illustration.

An opening end of the exterior body 15 is blocked by a sealing assembly 16, and thus the interior of the secondary battery 10 is tightly sealed. Respective insulating plates 17 and 18 are disposed on and under the electrode assembly 14. A positive electrode lead 19 passes through a though-hole in the insulating plate 17 and extends upward, and is welded to the lower surface of a filter 22, which is the bottom board of the sealing assembly 16. In the secondary battery 10, a cap 26, which is the top board of the sealing assembly 16 and electrically connected to the filter 22, serves as a positive electrode terminal. On the other hand, a negative electrode lead 20 passes through a though-hole in the insulating plate 18 and extends toward the bottom of the exterior body 15, and is welded to the inner surface of the bottom of the exterior body 15. In the secondary battery 10, the exterior body 15 selves as a negative electrode terminal. When the negative electrode lead 20 is placed on a terminal portion, the negative electrode lead 20 passes on the outside of the insulating plate 18 and extends toward the bottom of the exterior body 15, and is welded to the inner surface of the bottom of the exterior body 15.

The exterior body 15 is, for example, a cylindrical metal container having a closed-end. A gasket 27 is disposed between the exterior body 15 and the sealing assembly 16 to ensure that the interior of the secondary battery 10 is tightly sealed. The exterior body 15 has, for example, a grooved portion 21 which is formed by pressing a lateral surface from outside and which supports the sealing assembly 16. The grooved portion 21 is preferably formed annularly along the circumferential direction of the exterior body 15, and the upper surface thereof supports the sealing assembly 16 via the gasket 27.

The sealing assembly 16 has the filter 22, a lower vent member 23, an insulating member 24, an upper vent member 25, and the cap 26 which are stacked in the listed order from the electrode assembly 14 side. Each of the members constituting the sealing assembly 16 has, for example, a disk or ring shape, and the members other than the insulating member 24 are electrically connected to each other. The lower vent member 23 and the upper vent member 25 are connected to each other at respective middle portions and the insulating member 24 is interposed between respective circumferences. If the inner pressure of the battery increases by abnormal heat generation, for example, the lower vent member 23 ruptures to thereby cause the upper vent member 25 to swell toward the cap 26 and separate from the lower vent member 23, thereby breaking the electrical connection between the members. If the inner pressure further increases, the upper vent member 25 ruptures to discharge gas through an opening 26a of the cap 26.

Hereinafter, the positive electrode 11, the negative electrode 12, the separator 13 and the non-aqueous electrolyte constituting the secondary battery 10, in particular, a negative electrode active material included in a negative electrode mixture layer 32 constituting the negative electrode 12 will be described in detail.

[Negative Electrode]

FIG. 2 is a sectional view of a negative electrode 12 of an exemplary embodiment. The negative electrode 12 comprises a negative electrode current collector 30, a first negative electrode mixture layer 32a disposed on a surface of the negative electrode current collector 30, and a second negative electrode mixture layer 32b disposed on a surface of the first negative electrode mixture layer 3a. The thickness of the first negative electrode mixture layer 32a and the thickness of the second negative electrode mixture layer 32b may be the same or different from each other.

The negative electrode current collector 30 here used is, for example, foil of a metal, such as copper, which is stable in the electric potential range of the negative electrode, or a film in which such a metal is disposed on an outer layer. The thickness of the negative electrode current collector 30 is, for example, 5 μm to 30 μm. The first negative electrode mixture layer 32a and the second negative electrode mixture layer 32b (hereinafter, the first negative electrode mixture layer 32a and the second negative electrode mixture layer 32b may be sometimes collectively referred to as “negative electrode mixture layer 32”) each include a negative electrode active material and a water-soluble polymer material. The negative electrode mixture layer 32 may include a binder. Examples of the binder include fluoro resins, PAN, polyimide resins, acrylic resins, polyolefin resins, styrene-butadiene rubber (SBR), and nitrile-butadiene rubber (NBR). These may be used singly or may be used in combinations of two or more thereof.

The negative electrode active material is not particularly limited as long as it can reversibly intercalate and deintercalate lithium ions, and examples thereof include graphite particles, a Si material, a metal to be alloyed with lithium, such as tin (Sn), or an alloy or oxide including a metal element such as Sn. The negative electrode active material preferably includes graphite particles. The content of the graphite particles in the negative electrode active material can be, for example, 90 mass % to 100 mass %.

The graphite particles are, for example, natural graphite or artificial graphite without any particular limitation, and are preferably artificial graphite. The plane spacing (d₀₀₂) of the (002) plane with respect to the graphite particles for use in the present embodiment, according to a wide-angle X-ray diffraction method, is, for example, preferably 0.3354 um or more, more preferably 0.3357 tin or more, and preferably less than 0.340 nm, more preferably 0.338 nm or less. The crystallite size (Lc(002)) with respect to the graphite particles for use in the present embodiment, as determined according to an X-ray diffraction method, is, for example, preferably 5 nm or more, more preferably 10 nm or more, and preferably 300 nm or less, more preferably 200 nm or less. When the plane spacing (d₀₀₂) and the crystallite size (Lc(002)) satisfy the above respective ranges, the battery capacity of the secondary battery 10 tends to increase as compared with when the above respective ranges are not satisfied.

The graphite particles can be produced as follows, for example. The graphite particles having a desired size are obtained by pulverizing coke (precursor) serving as a main raw material, to a predetermined size, firing and graphitizing such a precursor pulverized, which is aggregated by an aggregation agent and then further pressure molded into a block, at a temperature of 2600° C. or more, and pulverizing and sieving a block molded product graphitized. The internal porosity of the graphite particles can be here adjusted by the particle size of the precursor pulverized, the particle size of the precursor aggregated, and the like. For example, the average particle size (median size D50 in terms of volume, the same applies to the following) of the precursor pulverized is preferably in the range from 12 μm to 20 μm. The internal porosity of the graphite particles can also be adjusted by the amount of a volatile component added to the block molded product. When a portion of the aggregation agent added to the coke (precursor) volatilizes in firing, the aggregation agent can be used as a volatile component. Examples of such an aggregation agent include pitch.

The graphite particles may be produced as follows, for example. The graphite particles having a desired size are obtained by pulverizing coke (precursor) serving as a main raw material, to a predetermined size, firing and graphitizing such a precursor pulverized, which is aggregated by an aggregation agent such as pitch, at a temperature of 2600° C. or more, and then sieving the resultant. The internal porosity of the graphite particles can be adjusted by the particle size of the precursor pulverized, the particle size of the precursor aggregated and the like. For example, the average particle size of the precursor pulverized is preferably in the range from 12 μm to 20 μm.

The water-soluble polymer material is preferably a material which acts as a thickener for slurry. The water-soluble polymer material can also act as the binder. Examples of the water-soluble polymer material include carboxymethyl cellulose (CMC) or salts thereof, poly(acrylic acid) (PAA) or salts thereof (PAA-Na, PAA-K, and the like which may be partially neutralized salts), and poly(vinyl alcohol) (PVA). These may be used singly or may be used in combinations of two or more thereof.

Next, a negative electrode active material and a water-soluble polymer material in the negative electrode mixture layer 32 are described with reference to FIG. 3. FIG. 3(A) is a schematic view showing one example of a cross section of a first negative electrode. mixture layer, and FIG. 3(B) is a schematic view showing one example of a second negative electrode mixture layer. As shown in FIG. 3(A), the first negative electrode mixture layer 32a includes a first negative electrode active material 34a and a first water-soluble polymer material 36a. As shown in FIG. 3(B), the second negative electrode mixture layer 32b includes second negative electrode active material 34b and a second water-soluble polymer material 36b. The ratio (S1/V1) of the amount (S1) of the first water-soluble polymer material 36a present in a surface of the first negative electrode active material 34a to the amount (V1) of the first water-soluble polymer material 36a present in voids between particles of the first negative electrode active material 34a is higher than the ratio (S2/V2) of the amount (S2) of the second water-soluble polymer material 36b present in a surface of the second negative electrode active material 34b to the amount (V2) of the second water-soluble polymer material 36b present in voids between particles of the second negative electrode active material 34b. In other words, most of the first water-soluble polymer material 36a is present in a surface of the first negative electrode active material 34a in the first negative electrode mixture layer 32a, and most of the second water-soluble polymer material 36b is present in voids between particles of the second .negative electrode active material 34b in the second negative electrode mixture layer 32b. According to the present configuration, not only a binding force between the negative electrode current collector 30 and the negative electrode mixture layer 32 can be increased, but also the negative electrode mixture layer 32 can be improved in permeability of an electrolyte solution, and thus a battery can be suppressed in deterioration in high-rate charge-discharge cycle characteristics. In addition, deterioration in low-rate charge cycle characteristics can also be suppressed. The amount of the water-soluble polymer material present in voids between particles of the negative electrode active material or a surface of the negative electrode active material is here a two-dimensional value determined by measurement of the cross section of the negative electrode mixture layer 32. The S1/V1 and S2/V2 can be compared by visualizing the water-soluble polymer material present in a surface of the negative electrode active material and the water-soluble polymer material present in voids between particles of the negative electrode active material in each layer of the first negative electrode mixture layer 32a and the second negative electrode mixture layer 32b, according to the following procedure.

<Method for Measuring S1/V1 and S2/V2>

(1) The cross section of the negative electrode mixture layer is exposed. Examples of the method for exposing the cross section include a method involving cutting out a portion of the negative electrode and processing the resultant with an ion milling apparatus (for example, IM4000PLUS manufactured by Hitachi High-Tech Corporation) to expose the cross section of the negative electrode mixture layer.

(2) SEM-EDX (for example, Flat QUAD manufactured by Bruker) is used to perform mapping of an element derived from the water-soluble polymer material in the cross section exposed of the negative electrode mixture layer, and take each image of the first negative electrode mixture layer 32a and the second negative electrode mixture layer 32b. The element derived from the water-soluble polymer material is here a characteristic element included in the water-soluble polymer material, and, for example, when the water-soluble polymer material is a Na salt of CMC, a Na element can be mapped. Measurement conditions of the cross section of the negative electrode mixture layer are as follows, fore example:

Magnification of cross section: 800×

Acceleration voltage of electron: 5 kV

Emission current: 10 μA

Probe current: High

Condenser lens: 1.0

Import time: 180 sec

(3) Comparison between S1/V1 and S2/V2 may be visually performed, when possible, from each image obtained with respect to the first negative electrode mixture layer 32a and the second negative electrode mixture layer 32b, or may be performed by binarizing such each image with image analysis software (for example, Image manufactured by National Institutes of Health) and converting S1/V1 and S2/V2 to numerical values.

The first negative electrode active material 34a and the second negative electrode active material 34b may be the same. The first water-soluble polymer material 36a and the second water-soluble polymer material 36b may be the same. The first negative electrode mixture layer 32a and the second negative electrode mixture layer 32b include a common material, resulting in cost reduction. Even if the first negative electrode mixture layer 32a and the second negative electrode mixture layer 32b include a common material, the respective methods for producing the first negative electrode mixture layer 32a and the second negative electrode mixture layer 32b can differ to thereby allow a relationship of S1/V1>S2/V2 to be satisfied, as described below.

At least any one of the group consisting of the first negative electrode active material 34a and the second negative electrode active material 34b may include a Si material. The Si material is a material that can reversibly intercalate and deintercalate lithium ions, and functions as a negative electrode active material. Examples of the Si material include Si, an alloy including Si, and silicon oxide such as SiOx (X is 0.8 to 1.6). The Si material is a negative electrode material that can more enhance battery capacity than a negative electrode active material. The content of the Si material in the first negative electrode active material 34a or the second negative electrode active material 34b is, for example, preferably 0.5 mass % to 10 mass %, more preferably 3 mass % to 7 mass % in view of, for example, an enhancement in battery capacity and suppression of deterioration in high-rate charge-discharge cycle characteristics.

Next, the method for producing the negative electrode 12 is described. The method for producing the negative electrode 12 includes a first negative electrode mixture layer formation step of coating a surface of the negative electrode current collector 30 with a first negative electrode mixture shiny prepared by kneading the first negative electrode active material 34a and the first water-soluble polymer material 36a, to form the first negative electrode mixture layer 32a, and a second negative electrode mixture layer formation step of coating a surface of the first negative electrode mixture layer 32a with a second negative electrode mixture slurry prepared by kneading the second negative electrode active material 34b and the second water-soluble polymer material 36b, to form the second negative electrode mixture layer 32b.

The first negative electrode mixture slurry can be prepared as follows, for example.

(1) The first negative electrode active material 34a and the first water-soluble polymer material 36a are mixed to produce a first mixture.

(2) An appropriate amount of a solvent is loaded to the first mixture, and the resultant is kneaded. The solvent is, for example, water. The amount of the solvent loaded is, fin example, 10 mass % to 30 mass % based on the total mass of the first negative electrode active material 34a and the first water-soluble polymer material 36a.

(3) A binder such as styrene-butadiene copolymer rubber (SBR) is loaded to the first mixture. Furthermore, the first mixture is stirred to adjust the first negative electrode mixture shiny.

The second negative electrode mixture slurry can be prepared as follows, for example.

(1) The second water-soluble polymer material 36b and a solvent are mixed to produce a second mixture. The solvent is, for example, water. The amount of the solvent is, for example, 40 mass % to 60 mass % based on the total mass of the second water-soluble polymer material 36b and the second negative electrode active material 34b to be next loaded.

(2) The second negative electrode active material 34b is loaded to the second mixture.

(3) The second mixture is kneaded. The solvent may be appropriately loaded additionally during the kneading.

(4) A binder is loaded to the second mixture. Furthermore, the second mixture is stirred to adjust the second negative electrode mixture slurry.

The shear force in leading of the first negative electrode mixture slurry is larger than the shear force in kneading of the second negative electrode mixture slurry. Thus, the second water-soluble polymer material 36b is more placed in voids between particles of the second negative electrode active material 34b in the second negative electrode mixture layer 32b, and the first water-soluble polymer material 36a is more placed in a surface of the first negative electrode active material 34a in the first negative electrode mixture layer 32a. According to the present configuration, permeability of an electrolyte solution in the second negative electrode mixture layer on the outer surface side, in contact with the electrolyte solution, and adhesiveness between the first negative electrode mixture layer and the negative electrode current collector 30 are improved, and thus the secondary battery 10 is suppressed in deterioration high-rate charge-discharge cycle characteristics. When a Si material to be largely expanded and contracted according to charge and discharge is included in at least one of the group consisting of the first negative electrode mixture layer 32a and the second negative electrode mixture layer 32b, the above effects are remarkably exerted. In the present disclosure, “kneading” refers to admixing of a mixture including a negative electrode active material, a water-soluble polymer, and a solvent so that the shear force is applied.

Thereafter, both sides of the negative electrode current collector 30 are coated with the first negative electrode mixture slurry, the resultant coatings are dried (first negative electrode mixture layer formation step), thereafter both sides of the first negative electrode mixture layer 32a are coated with the second negative electrode mixture slurry, and the resulting coatings are dried (second negative electrode mixture layer formation step). Furthermore, the first negative electrode mixture layer 32a and the second negative electrode mixture layer 32b can be rolled by a roller to thereby form the negative electrode mixture layer 32. The first negative electrode mixture layer 32a before drying can also be coated with the second negative electrode mixture slurry.

[Positive Electrode]

The positive electrode 11 is configured from, for example, a positive electrode current collector of metal foil or the like, and a positive electrode mixture layer formed on the positive electrode current collector. The positive electrode current collector here used can be, for example, foil of a metal, such as aluminum which is stable in the electric potential range of the positive electrode, or a film in which such a metal is disposed on an outer layer. The positive electrode mixture layer includes, for example, a positive electrode active material, a binder, and a conductive agent.

The positive electrode 11 can be produced by, for example, coating the positive electrode current collector with a positive electrode mixture slurry including, for example, a positive electrode active material, a binder, and a conductive agent, and drying the resultant to thereby form the positive electrode mixture layer, and then rolling the positive electrode mixture layer.

Examples of the positive electrode active material can include a lithium transition metal oxide containing a transition metal element such as Co, Mn or Ni. Examples of the lithium transition metal oxide include LiₓCoO₂, LiₓNiO₂, LiₓMnO₂, LiₓCo_{y}Ni_{1-y}O₂, LiₓCo_{y}M_{1-y}O_{z}, LiₓNi_{1-y}M_{y}O_{z}, LiₓMn₂O₄, LiₓMn_{2-31 y}M_{y}O₄, LiMPO₄, Li₂MPO₄F (M; at least one of Na, Mg, Sc, Y, Mn, Fe, Co, Ni, Cu, Zn, Al, Cr, Pb, Sb, and B, 0<x≤1.2, 0<y≤0.9, 2.0≤z≤2.3). These may be used singly or a plurality thereof may be mixed and used. The positive electrode active material preferably includes a lithium/nickel complex oxide such as LiₓNiO₂, LiₓCo_{y}Ni_{1-y}O₂, or LiₓNi_{1-y}M_{y}O_{z} (M; at least one of Na, Mg, Se, Y, Mn, Fe, Co, Ni, Cu, Zn, Al, Cr, Pb, Sb, and B, 0<x≤1.2, 0<y≤0.9, 2.0≤z≤2.3) from the viewpoint that the capacity of the non-aqueous electrolyte secondary battery can be increased.

Examples of the conductive agent include carbon particles such as carbon black (CB), acetylene black (AB), Ketjenblack, and graphite. These may be used singly or may be used in combinations of two or more thereof.

Examples of the binder include fluoro resins such as polytetrafluoroethylene (PTFE) and poly(vinylidene fluoride) (PVdF), polyacrylonitrile (PAN), polyimide resins, acrylic resins, and polyolefin resins. These may be used singly or may be used in combinations of two or more thereof.

[Separator]

For example, an ion-permeable and insulating porous sheet is used as the separator 13. Specific examples of the porous sheet include a microporous thin film, woven fabric, and nonwoven fabric. Suitable examples of the material for the separator include olefin resins such as polyethylene and polypropylene, and cellulose. The separator 13 may be a laminate including a cellulose fiber layer and a layer of fibers of a thermoplastic resin such as an olefin resin. The separator may be a multi-layered separator including a polyethylene layer and a polypropylene layer, and a surface of the separator 13 to be used may be coated with a material such as an aramid resin or ceramic.

[Non-Aqueous Electrolyte]

The non-aqueous electrolyte includes a non-aqueous solvent and an electrolyte salt dissolved in the non-aqueous solvent. The non-aqueous electrolyte is not limited to a liquid electrolyte (electrolyte solution), and may be a solid electrolyte using a gel polymer or the like. Examples of the non-aqueous solvent that can be used include esters, ethers, nitriles such as acetonitrile, amides such as dimethylformamide, and any mixed solvent of two or more thereof. The non-aqueous solvent may contain a halogen-substituted product formed by replacing at least a portion of hydrogen of any of the above solvents with a halogen atom such as fluorine.

Examples of the esters include cyclic carbonate esters such as ethylene carbonate (EC), propylene carbonate (PC), and butylene carbonate, chain carbonate esters such as dimethyl carbonate (DMC), ethyl methyl carbonate (EMC), diethyl carbonate (DEC), methyl propyl carbonate, ethyl propyl carbonate, and methyl isopropyl carbonate, cyclic carboxylate esters such as γ-butyrolactone and γ-valerolactone, and chain carboxylate esters such as methyl acetate, ethyl acetate, propyl acetate, methyl propionate (MP), and ethyl propionate.

Examples of the ethers include cyclic ethers such as 1,3-dioxolane, 4-methyl-1,3-dioxolane, tetrahydrofuran, 2-methyltetrahydrofuran, propylene oxide, 1,2-butylene oxide, 1,3-dioxane, 1,4-dioxane, 1,3,5-trioxane, furan, 2-methylfuran, 1,8-cineole, and crown ethers, and chain ethers such as 1,2-dimethoxyethane, diethyl ether, dipropyl ether, diisopropyl ether, dibutyl ether, dihexyl ether, ethyl vinyl ether, butyl vinyl ether, methyl phenyl ether, ethyl phenyl ether, butyl phenyl ether, pentyl phenyl ether, methoxytoluene, benzyl ethyl ether, di phenyl ether, dibenzyl ether, o-dimethoxybenzene, 1,2-diethoxyethane, 1,2-dibutoxyethane, diethylene glycol dimethyl ether, diethylene glycol diethyl ether, diethylene glycol dibutyl ether, 1,1-dimethoxymethane, 1,1-diethoxyethane, triethylene glycol dimethyl ether, and tetraethylene glycol dimethyl ether.

Preferable examples of the halogen-substituted product far use include a fluorinated cyclic carbonate ester such as fluoroethylene carbonate (FEC), a fluorinated chain carbonate ester, and a fluorinated chain carboxylate ester such as methyl fluoropropionate (FMP).

The electrolyte salt is preferably a lithium salt. Examples of the lithium salt include LiBF₄, LiClO₄, LiPF₆, LiAsF₆, LiSbF₆, LiAlCl₄, LiSCN, LiCF₃SO₃, LiCF₃CO₂, Li(P(C₂O₄)F₄), LiPF₆₋ₓ(CₙF₂ₙ₊₁)ₓ(where 1<x<6, and n is 1 or 2), LiB₁₀Cl₁₀, LiCl, LiBr, LiI, chloroborane lithium, lithium lower aliphatic carboxylate, borate salts such as Li₂B₄O₇ and Li(B(C₂O₂), and imide salts such as LiN(SO₂CF₃)₂ and LiN(C₁F₂ₗ₊₁SO₂)(CₘF₂ₘ₊₁SO₂) {where l and m are integers of 1or more}. These lithium salts may be used singly or a plurality thereof may be mixed and used. Among these, LiPF₆ is preferably used in view of ionic conductivity, electrochemical stability, and other properties. The concentration of the lithium salt is preferably 0.8 to 1.8 mol per liter of the solvent.

### EXAMPLES

Hereinafter, the present disclosure will be further described with reference to Examples, but the present disclosure is not intended to be limited to such Examples.

### Example

[Production of Positive Electrode]

Aluminum-containing lithium nickel cobaltate (LiN_{0.88}Co_{0.09}Al_{0.03}O₂) was used as a positive electrode active material. Mixed were 100 parts by mass of the positive electrode active material, 1 part by mass of graphite as a conductive agent, and 0.9 parts by mass of a poly(vinylidene fluoride) powder as a binder, and an appropriate amount of N-methyl-2-pyrrolidone (NMP) was further added thereto to prepare a positive electrode mixture slurry. Both sides of a positive electrode current collector made of aluminum foil (thickness 15 μm) were coated with the shiny by a doctor blade method, and the resultant coatings were dried and then rolled by a roller to thereby produce a positive electrode in which a positive electrode mixture layer was formed on each of both sides of the positive electrode current collector.

[Production of Negative Electrode]

First, a first negative electrode mixture slurry was prepared. Mixed were 95 parts by mass of graphite particle and 5 parts by mass of SiO, and the resultant was adopted as a negative electrode active material. Mixed were 100 parts by mass of the negative electrode active material and 1 part by mass of carboxymethyl cellulose (CMC), 20 parts by mass of water was. added to the mixture, and the resultant was kneaded. After 1 part by mass of styrene-butadiene copolymer rubber (SBR) was further added to the mixture, the resultant was stirred to thereby prepare a first negative electrode mixture slurry.

Next, a second negative electrode mixture slurry was prepared. First, 50 parts by mass of water and 1 part by mass of CMC were mixed, 100 parts by mass of the negative electrode active material was loaded to the mixture, and the resultant was kneaded. After 1 part by mass of SBR was further added to the mixture, the resultant was stirred to thereby prepare a second negative electrode mixture slurry. The shear force in kneading of the first negative electrode mixture slurry was larger than the shear force in kneading of the second negative electrode mixture slurry.

Both sides of a negative electrode current collector made of copper foil were coated with the first negative electrode mixture slurry by a doctor blade method, and the resultant coatings were dried to thereby form a first negative electrode mixture layer. The first negative electrode mixture layer was further coated with the second negative electrode mixture slurry, and the resultant coating was dried to thereby form a second negative electrode mixture layer. The coating mass ratio per unit area between the first negative electrode mixture slurry and the second negative electrode mixture slurry was here 5:5. The first negative electrode mixture layer and the second negative electrode mixture layer were rolled by a roller to thereby produce a negative electrode. The cross section of the negative electrode was observed, and S1/V1>S2/V2 was satisfied.

[Production of Non-Aqueous Electrolyte]

5 parts by mass of vinylene carbonate (VC) was added to a 100 parts by mass of non-aqueous solvent obtained by mixing ethylene carbonate (EC) and dimethyl carbonate (DMC) in a volume ratio of 1:3, LiPF₆ was dissolved therein at a concentration of 1.5 mol/L, and the resultant was adopted as a non-aqueous electrolyte.

[Production of Non-Aqueous Electrolyte Secondary Battery]

(1) A wound-type electrode assembly was produced by attaching a positive electrode lead to the positive electrode current collector and attaching a negative electrode lead to the negative electrode current collector, and then winding the positive electrode and the negative electrode with a separator made of a macroporous membrane made of polyethylene being interposed therebetween.

(2) Respective insulating plates were disposed on and under the electrode assembly, the negative electrode lead was welded to an exterior body, and the positive electrode lead was welded to the sealing assembly, to thereby house the electrode assembly in the exterior body.

(3) The non-aqueous electrolyte was injected in the exterior body by a depressurizing system, the opening end of the exterior body was sealed b the sealing assembly via a gasket, and the resultant was adopted as a non-aqueous electrolyte secondary battery.

### Comparative Example 1

The same manner as in Examples was performed except that the first negative electrode mixture slurry was used to form a second negative electrode mixture layer.

### Comparative Example 2

The same manner as in Examples was performed except that the second negative electrode mixture slurry was used to form a first negative electrode mixture layer.

### Comparative Example 3

The same manner as in Examples was performed except that the second negative electrode mixture slurry was used to form a first negative electrode mixture layer and the first negative electrode mixture slurry was used to form a second negative electrode mixture layer.

[Measurement of Capacity Retention Rate in High-Rate Cycle]

Each of the non-aqueous electrolyte secondary batteries of Examples and Comparative Examples was charged to 4.2 V at a constant current of 1 C (4600 mA) and then charged to 1/50 C at a constant voltage of 4.2 V under an environmental temperature of 25° C. Thereafter, each of the batteries was discharged to 2.5 V at a constant current of 0.5 C. Such charge and discharge were defined as one cycle, and performed for 100 cycles. According to the following expression, the capacity retention rate in a high-rate cycle of each of the non-aqueous electrolyte secondary batteries of Examples and Comparative Examples was determined.

Capacity retention rate=(Discharge capacity at 100^{th} cycle/Discharge capacity at 1^{st} cycle)×100

[Measurement of Capacity Retention Rate in Low-Rate Cycle]

Each of the non-aqueous electrolyte secondary batteries of Examples and Comparative Examples was charged to 4.2 V at a constant current of 0.3 C (1380 mA) and then charged to 1/50 C at a constant voltage of 4.2 V under an environmental temperature of 25° C. Thereafter, each of the batteries was discharged to 2.5 V at a constant current of 0.5 C. Such charge and discharge were defined as one cycle, and performed for 50 cycles. According to the following expression, the capacity retention rate in a high-rate charge-discharge cycle of each of the non-aqueous electrolyte secondary batteries of Examples and Comparative Examples was determined.

Capacity retention rate=(Discharge capacity at 50^{th} cycle/Discharge capacity at 1^{st} cycle)×100

[Measurement of Capacity Retention Rate in Low-Rate Charge-Discharge Cycle]

Each of the non-aqueous electrolyte secondary batteries of Examples and Comparative Examples was charged to 4.2 V at a constant current of 0.3 C (1380 mA) and then charged to 1/50 C at a constant voltage of 4.2 V under an environmental temperature of 25° C. Thereafter, each of the batteries was discharged to 2.5 V at a constant current of 0.5 C. Such charge and discharge were defined as one cycle. and performed for 500 cycles. According to the following expression, the capacity retention rate in a high-rate charge-discharge cycle of each of the non-aqueous electrolyte secondary batteries of Examples and Comparative Examples was determined.

Capacity retention rate=(Discharge capacity at 500^{th} cycle/Discharge capacity at 1^{st} cycle)×100

Table 1 summarized the results of the capacity retention rate in each charge-discharge cycle of each of the non-aqueous electrolyte secondary batteries of Examples and Comparative Examples. It was indicated that, as the value of the capacity retention rate in a charge-discharge cycle was higher, deterioration in charge-discharge cycle characteristics was more suppressed.

TABLE 1

| | Slurry (negative electrode) | | Capacity retention rate (%) | | |
|---|---|---|---|---|---|
| | First | Second | High- | Initial | Low- |
| | layer | layer | rate | low-rate | rate |
| Example | First | Second | 83 | 94 | 81 |
| Comparative | First | First | 72 | 85 | 65 |
| Example 1 | | | | | |
| Comparative | Second | Second | 71 | 96 | 76 |
| Example 2 | | | | | |
| Comparative | Second | First | 40 | 92 | 72 |
| Example 3 | | | | | |

First layer: first negative electrode mixture layer, Second layer: second negative electrode mixture layer

The secondary batteries of Examples each exhibited a high capacity retention rate in any cycle test as compared with the secondary batteries of Comparative Examples, and were each good particularly in high-rate charge-discharge cycle characteristics as compared with those of Comparative Examples. It was considered that the layer on the outer surface side, in contact with an electrolyte solution, was improved in permeability of the electrolyte solution and the inside layer in contact with the negative electrode current collector was improved in adhesiveness to the negative electrode current collector in each of the negative electrode mixture layers of Examples.

### REFERENCE SIGN LIST

10 secondary battery, 11 positive electrode, 12 negative electrode, 13 separator, 14 electrode assembly, 15 exterior body, 16 sealing assembly, 17, 18 insulating plate, 19 positive electrode lead, 20 negative electrode lead, 21 grooved portion, 22 filter, 23 lower vent member, 24 insulating member, 25 upper vent member, 26 cap, 26a opening, 27 gasket, 30 negative electrode current collector, 32 negative electrode mixture layer, 32a first negative electrode mixture layer, 32b second negative electrode mixture layer, 34a first negative electrode active material, 34b second negative electrode active material, 36a first water-soluble polymer material, 36b second water-soluble polymer material

1. A negative electrode for a non-aqueous electrolyte secondary battery, comprising:
a negative electrode current collector;
a first negative electrode mixture layer disposed on a surface of the negative electrode current collector; and
a second negative electrode mixture layer disposed on a surface of the first negative electrode mixture layer, wherein
the first negative electrode mixture layer includes a first negative electrode active material and a first water-soluble polymer material,
the second negative electrode mixture layer includes a second negative electrode active material and a second water-soluble polymer material, and
a ratio (S1/V1) of an amount (S1) of the first water-soluble polymer material present in a surface of the first negative electrode active material to an amount (V1) of the first water-soluble polymer material present in voids between particles of the first negative electrode active material is higher than a ratio (S2/V2) of an amount (S2) of the second water-soluble polymer material present in a surface of the second negative electrode active material to an amount (V2) of the second water-soluble polymer material present in voids between particles of the second negative electrode active material.

2. The negative electrode for a non-aqueous electrolyte secondary battery according to claim 1, wherein at least one of the group consisting of the first negative electrode active material and the second negative electrode active material includes a Si material, and a content of the Si material is 0.5 mass % to 10 mass % based on a mass of the first negative electrode active material or the second negative electrode active material including the Si material.

3. A non-aqueous electrolyte secondary battery comprising:
the negative electrode for a non-aqueous electrolyte secondary battery according to claim 1;
a positive electrode; and
a non-aqueous electrolyte.

4. A method for producing a negative electrode for a non-aqueous electrolyte secondary battery, including:
a first negative electrode mixture layer formation step of coating a surface of a negative electrode current collector with a first negative electrode mixture slurry prepared by kneading a first negative electrode active material and a first water-soluble polymer material, to form a first negative electrode mixture layer; and
a second negative electrode mixture layer formation step of coating a surface of the first negative electrode mixture layer with a second negative electrode mixture slurry prepared by kneading a second negative electrode active material and a second water-soluble polymer material, to form a second negative electrode mixture layer; wherein
a shear force in kneading of the first negative electrode mixture is larger than a shear force in kneading of the second negative electrode mixture slurry.
